(19) United States
(12) Patent Application Publication
(10) Pub. No.: US 2010/0312449 A1
(43) Pub. Date: Dec. 9, 2010

(54) SYSTEM AND METHOD FOR CONTROLLING TRACTION IN A TWO-WHEELED VEHICLE

(75) Inventors: Sergio Matteo Savaresi, Cremona (CR) (IT); Matteo Corno, Bellusco (MB) (IT); Simone Formentin, San Giorgio Su Legnano (MI) (IT); Luca Fabbri, Santa Maria Di Sala (IT)

Correspondence Address: LUCAS & MERCANTI, LLP, 475 PARK AVENUE SOUTH, 15TH FLOOR, NEW YORK, NY, 10016, US

(73) Assignees: PIAGGIO & C. S.P.A., Pontedera (PI) (IT); POLITECNICO DI MILANO, Milan (MI) (IT)

(21) Appl. No.: 12/788,894

(22) Filed: May 27, 2010

(30) Foreign Application Priority Data
Jun. 9, 2009 (IT) MI2009A 001013

(51) Int. Cl. G06F 19/00

(52) U.S. Cl. 701/82

(57) ABSTRACT

The present invention refers to a system and method for controlling traction in a two-wheeled vehicle comprising a torque controlled motor and a plurality of sensors for instantaneously measuring driving parameters (v, φ, θ, ω, x, a, RPM, gear) of said vehicle, the method comprising the steps of determining a reference slip value (λ₀) as a function of a parameter (θ) representative of a torque request from a user detected by means of the plurality of sensors; estimating an instantaneous slip value (λₛ); determining a first component (t_{CL}) of a requested torque signal to the motor based upon the difference between the reference slip value (λ₀) and the instantaneous slip value (λₛ); and is characterised in that the reference slip value (λ₀) is determined by means of a torque-slip map correlating the parameter (θ) representative of a torque request with a slip (λ), the map varying as a function of a longitudinal speed (v) and a rolling angle (f) of the two-wheeled vehicle detected by means of the plurality of sensors.

### CROSS-REFERENCE TO RELATED APPLICATION

This application claims the benefit of priority from Italian Patent Application No. MI2009A 001013, filed Jun. 9, 2009, the contents of which are incorporated herein by reference.

### FIELD OF THE INVENTION

The present invention refers to a system and to a method for controlling the traction in a two-wheeled vehicle.

### BACKGROUND OF THE INVENTION

In vehicles in general, and in particular in two-wheeled vehicles or motor vehicles, the control of the traction is carried out by controlling the slip of the drive wheels during acceleration, in a way such as to ensure good road-holding qualities and to thus improve the safety and driving conditions of the vehicle itself.

In particular, a non-zero longitudinal slip level is necessary in order to give traction in the direction of movement of the vehicle.

However, when a vehicle has to deal with a curve, having a non zero longitudinal slip value causes a reduction of the lateral force that the tyre can exert. This effect is particularly critical in two-wheeled vehicles in which the lateral force exerted by the tyres not only allows the vehicle to complete the curve, but it also stabilises the roll dynamic.

Therefore, in a motor vehicle, there are opposite slip necessities according to whether it is running on a straight or about to tackle a curve.

A first known solution for controlling the traction in motor vehicles promotes safety by limiting the level of slip of the drive wheel irrespective of the instantaneous lean conditions.

Such a method carries out a closed loop control which estimates the instantaneous slip value based upon instantaneous measuring values, and adjusts the torque delivered by the motor of the vehicle so as to keep the instantaneous slip value below a limit value.

In order to ensure a high level of lateral adhesion for each lean condition, in such a known approach the limit slip level is chosen in a conservative manner.

The conservative choice of the limit slip value, however, leads to a lower performance when the motor vehicle is in those conditions in which a slip level greater than that of the limit would offer a greater traction and therefore a greater acceleration without bringing the vehicle into an unstable condition.

A second known method for controlling the traction in motor vehicles is applied to racing vehicles. Such systems are designed and calibrated to ensure the maximum performances on known tracks. They are thus focused on the performance aspects and are not developed to ensure sturdiness when facing variable adhesion conditions. Such systems are thus difficult to apply onto production vehicles.

In the known closed loop control methods, the estimation of the instantaneous slip value is usually carried out in an approximate manner by simply equaling it to the difference between the rotational speed of the front and rear wheels.

In such a way, without taking into account further different parameters which affect the instantaneous slip, the control is based upon an imprecise feedback value, and is therefore not very reliable since possible imprecisions in the feedback value lead to an equally imprecise reaction of the system.

Moreover, the closed loop systems, even though they can ensure greater sturdiness, are generally slower at responding to the reference variations with respect to feedforward control systems.

Finally, a feedforward method for controlling the traction is known that adjusts the torque delivered by the motor, and consequently the instantaneous slip, based upon some known input parameters, such as the revs of the motor, the inserted gear, the position of the throttle valve and so on.

Such a method for controlling, not being based upon the adjustment of the feedback of the instantaneous slip, is not able to adapt to the instantaneous conditions of the driving surface and of the vehicle, like for example the adhesion offered by the road surface or the wear condition of the tyres, and therefore can only be used in competitive contexts where it is possible to map and describe with a high level of detail each single manoeuvre of the track.

### SUMMARY OF THE INVENTION

The purpose of the present invention is that of avoiding the aforementioned drawbacks and in particular that of devising a method for controlling traction in a two-wheeled vehicle that is able to ensure a good level of stability of the vehicle whilst offering the best performances possible to be achieved dependent upon the particular driving condition.

Another purpose of the present invention is that of providing a method for controlling traction in a two-wheeled vehicle which is able to estimate the instantaneous slip value of the motor vehicle in a precise manner, achieving in such a way a more sturdy control.

A further purpose of the present invention is that of devising a method for controlling traction in a two-wheeled vehicle which is able to adapt to the instantaneous conditions of the vehicle and of the road surface, without however renouncing a rapid system reaction.

The last but not least purpose of the present invention is that of making a system for controlling the traction in a two-wheeled vehicle which is able to implement the method for controlling according to the invention.

These and other purposes according to the present invention are achieved by making a system and a method for controlling traction in a two-wheeled vehicle as outlined in the independent claims.

Further characteristics of the system and of the method for controlling traction in a two-wheeled vehicle are object of the dependent claims.

The characteristics and the advantages of a system and of a method for controlling traction in a two-wheeled vehicle according to the present invention shall become clearer from the following description, given as an example and not for limiting purposes, with reference to the attached schematic drawings.

### BRIEF DESCRIPTION OF THE FIGURES

FIG. 1 is a schematic representation of the system for controlling implementing the method for controlling traction in a two-wheeled vehicle according to the present invention;

FIG. 2 is a block diagram which represents the method for controlling traction in a two-wheeled vehicle according to the present invention;

FIGS. 3a and 3b are a schematic representation of the possible maps of thresholds used in the method for controlling traction in a two-wheeled vehicle according to the present invention;

FIG. 4 is a graph representing a possible embodiment of the generator of a reference slip used in the method for controlling traction in a two-wheeled vehicle according to the present invention.

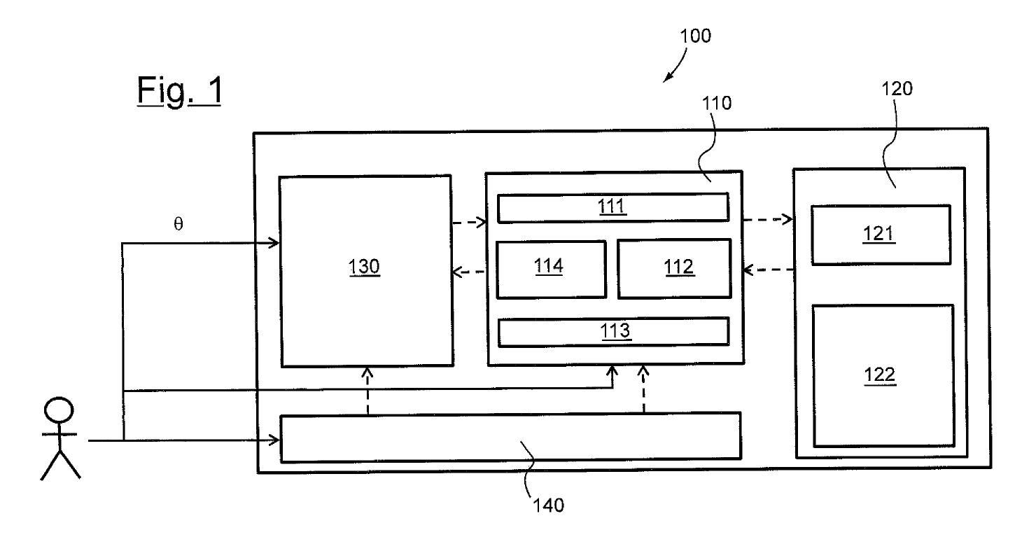

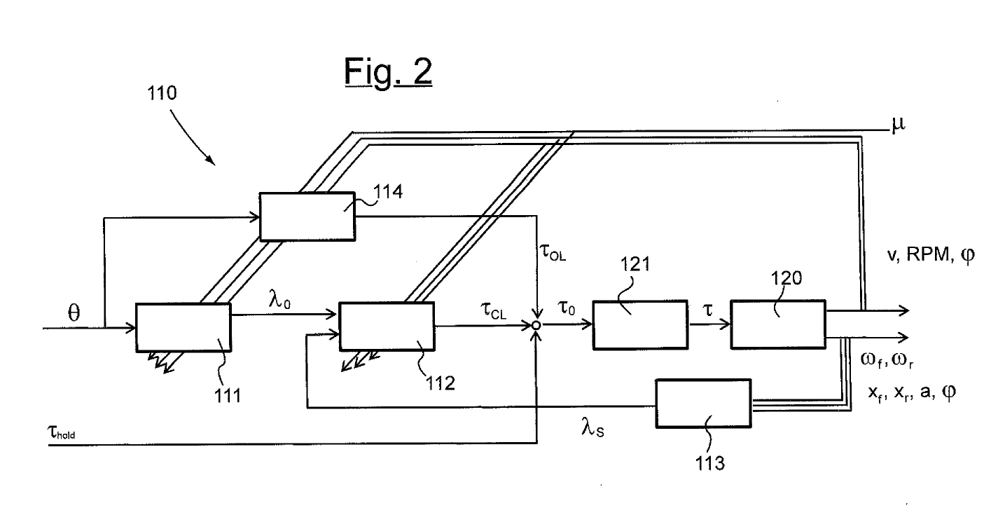

### DETAILED DESCRIPTION OF THE INVENTION

With reference to the figures, a system for controlling traction in a two-wheeled vehicle, is shown, wholly indicated with reference numeral 100.

The system for controlling the traction 100 comprises a control block 110 coupled with a motor 121 of a two-wheeled vehicle 120, in which the motor 121 can be torque controlled, i.e. able to deliver an instantaneous torque t requested by the system 100.

In particular, the adjustment of the requested torque is generally obtained by varying the ignition advance of every cylinder, or, preferably, through the electronic control of the throttle valve so as to be able to exploit the entire torque range that the motor 121 is able to generate, or even by combining the two methods.

In vehicles with a motor 121 in which the torque can be controlled, a system for controlling the motor (not illustrated) is foreseen that translates the request of a user carried out through the accelerator, in a reference torque t. The translation is carried out by means of maps which relate the position of the accelerator, the gear inserted and the number of revs of the motor to the torque t requested to the system for controlling the motor 121.

When the control block 110 of the system for controlling the traction 100 according to the present invention is active, it determines the instantaneous torque necessary for such a system 100 providing, as an input to the motor 121, a corresponding signal t₀ that replaces the reference torque normally generated by the conventional system for controlling the motor.

It is also foreseen for there to be a plurality of sensors 122 suitable for offering, to the control block 110, driving parameter measurements of the motor vehicle 120, amongst which a measurement based upon which the instantaneous rolling angle f of the vehicle can be determined.

In order to determine the instantaneous rolling angle f, the sensors 122 can comprise, for example, a meter for measuring the distance from the ground at the two sides of the vehicle 120 from which it is possible to derive a direct measurement of the rolling angle f, or an accelerometer or a rate gyro able to provide measurements based upon which the instantaneous rolling angle f can be estimated, like for example as described in the Italian patent application number MI2007A000559.

According to the present invention, the control block 110 comprises a reference generator 111 connected as an input to a torque request source expressed dependent upon the gear inserted and upon the motor speed expressed in terms of number of motor revs RPM, through a parameter θ representative of a torque request, like for example the angular position of the accelerator or of the throttle valve.

Hereafter, a reference to the angular position of the accelerator or of the throttle valve should be understood to be a non limiting example representation of the parameter θ representative of a torque request. Based upon the parameter θ representative of an instantaneous torque request, of the speed v and of the rolling angle f at which the vehicle is running, determined by means of the sensors 122, the reference generator 111 provides, as an input to a closed loop controller 112, a reference slip value λ₀ which is compared with an instantaneous slip value λₛ estimated by means of a slip reconstructor 113.

Based upon the difference between the reference slip value λ₀ and the instantaneous slip value λₛ, the closed loop controller 112 determines a first component t_{CL} of the signal t₀ corresponding to the instantaneous torque requested to the motor 121.

Moreover, a feedforward controller 114 is preferably foreseen, which determines a second component t_{OL} of the signal t₀ corresponding to the instantaneous torque requested to the motor 121 based upon the instantaneous conditions of the vehicle 120 such as its speed v, the rolling angle f, the motor speed expressed in terms of number of motor revs RPM and so on, in addition to the angular position θ of the accelerator or of the throttle valve.

Such measurements are detected by means of the plurality of sensors 122 foreseen on the motor vehicle 120.

The combined action of the closed loop controller 112 and of the feedforward controller 114 is mixed through a suitable variable mixing factor μ dependent upon the speed v and the rolling angle f at which the motor vehicle is running, so as to ensure a greater promptness of the response of the system or, vice versa, a greater adaptability to the variations of the conditions of the vehicle or of the road.

The system for controlling the traction 100 also preferably comprises a supervision block 130 that manages the activation of the control block 110 as a function of the instantaneous slip λₛ and of the variation speed of the angular position θ of the accelerator or of the throttle valve.

Finally it is preferably foreseen for there to be a user interface 140 comprising a plurality of selectors that allow a user to set the managing parameters of the control block 110.

In particular, the activation thresholds of the control block 110 can be selected, i.e. specifically, the slip λ or the variation speed of the angular position θ of the accelerator or of the throttle valve as a function of the speed of the vehicle v and of the rolling angle f.

The user interface 140 is also used to select further parameters such as, for example, the mixing parameter μ, and to display the current selections, possibly showing the dependencies of some parameters, like for example the dependence of the mixing parameter μ on the speed of the vehicle v and on the rolling angle f.

The operation of the system for controlling the traction 100 in a two-wheeled vehicle is the following.

The control block 100 intervenes only when there are certain conditions that indicate the need for a control of the traction like for example a loss of traction of the rear wheel.

For such a purpose, beyond a predetermined speed v, the supervision block 130 places the control block 110 in a condition of potentially being able to intervene in the case in which certain activation conditions have occurred.

In particular, two alternative activation conditions are used, beyond which the control block 110 is activated: a minimum slip λₘᵢₙ or a minimum speed of variation of the parameter θ representative of an instantaneous torque request like for example a minimum opening speed of the accelerator or of the throttle valve.

The activation conditions can be summarised as follows:

$$activation logic \text{:} \{ \begin{matrix}λ > {λ}_{min} ( v , ϕ ) \\ OR \\ \frac{d ( θ )}{d t} > {\overline{θ}}^{*} ( v , ϕ ) .\end{matrix}$$

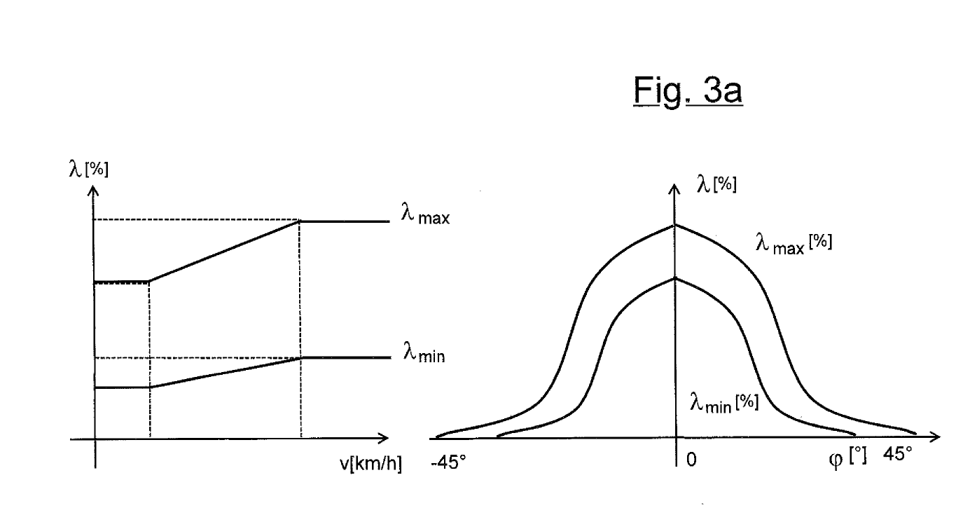

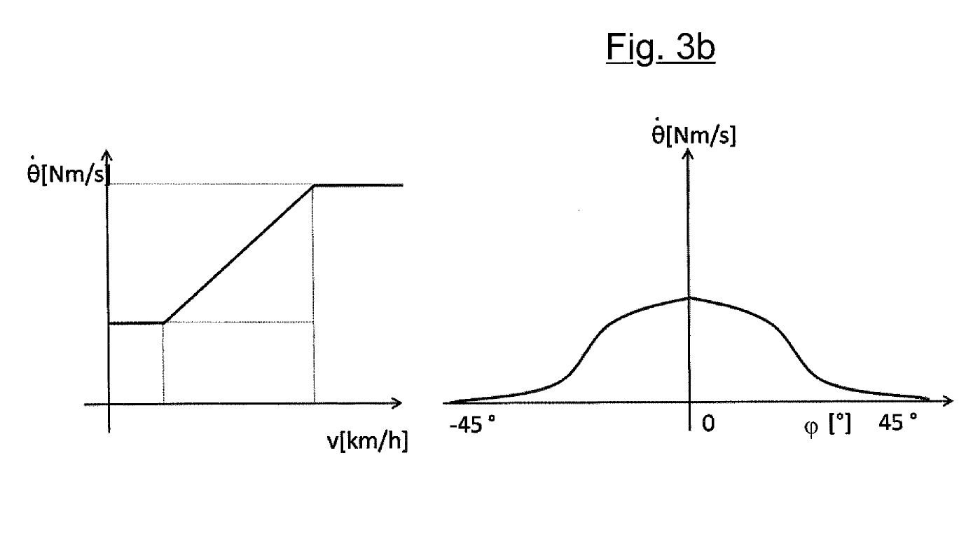

The minimum sliding values λmin and of minimum variation of the angular position θ of the accelerator or of the throttle valve are defined a priori through the initial selection of special maps of thresholds, as illustrated in the FIGS. 3a and 3b, which correlate the maximum and minimum slip values allowed and the minimum variation allowed of the angular position θ of the accelerator or of the throttle valve with the speed v and the rolling angle f at which the vehicle is running.

The use of the opening speed of the accelerator or of the throttle valve as the threshold of activation of the control block 110 in addition to the slip, advantageously makes it possible to advance the intervention of the control system 100 before there is a sudden loss of road grip due to a sudden torque request by the user.

Once one of the two activation conditions has been reached, the instantaneous state of the vehicle is stored in the control block 110.

In particular, at least the instantaneous torque delivered by the motor t_{hold}, the slip value of the rear wheel λ_{hold}, the rolling angle f_{hold} of the vehicle and the angular position θ_{hold} of the accelerator or of the throttle valve are stored.

Part of such values are used by the reference generator 111 of the control block 110 to generate a reference slip λ₀.

The remaining values are, on the other hand, used to avoid discontinuity at the activation and of the deactivation of the control block 110.

The reference slip λ₀ is generated based upon a system with two thresholds so as to give a feeling of control over the motor vehicle even when the control block 110 is active.

In particular, the instantaneous values of the angular position θ_{hold} of the accelerator or of the throttle valve and of the slip λ_{hold} upon activation of the control block are used to generate a torque-slip map which correlates the slip with the angular position θ of the accelerator or of the throttle valve and based upon which each time the reference slip value λ₀ is identified.

Such a torque-slip map must satisfy the following conditions.

When the accelerator is completely open the slip is equal to the maximum slip allowed for the particular speed and rolling angle at which the motor vehicle is running: λ₀=λₘₐₓ(v·φ). The maximum slip value λₘₐₓ can be obtained dependent upon the speed and the rolling angle through the map of the initially chosen thresholds.

When the angular opening position θ of the accelerator or of the throttle valve is equal to the value stored at the activation θ_{hold} and the value of the rolling angle f is equal to the initial rolling angle f_{hold}, then the reference slip is set equal to the slip value stored at the moment of activation λ₀=λ_{hold}, so as to ensure continuity of the control action at the moment of ignition of the system 100 for controlling the traction.

When the angular opening position θ of the accelerator or of the throttle valve is zero, then the reference slip λ₀ is set equal to zero.

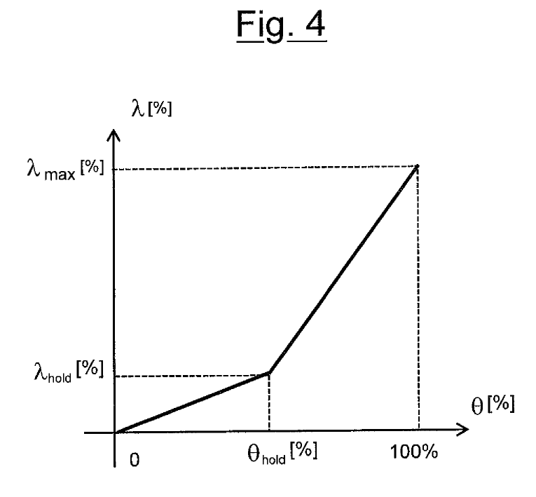

FIG. 4 illustrates a non limiting example embodiment of a map that satisfies the indicated conditions.

A reference generator 111 which uses such a map to determine the reference slip λ₀ allows the user to control the slip by acting upon the accelerator. In particular, when the accelerator is completely open, the user is requesting the maximum acceptable slip λₘₐₓ for the speed v and the rolling angle f at which the vehicle is running.

The reference slip λ₀ is compared with an estimated slip value λₛ obtained by means of the slip reconstructor 113.

The slip λ of a wheel of the motor vehicle 120 is defined as follows:

$$λ = \frac{ω r - v}{ω r}$$

in which ω is the rotational speed of the analysed wheel of the motor vehicle, r is the instantaneous radius of such a wheel and v is the longitudinal speed of the vehicle measured at its own centre of mass.

The instantaneous radius r of the wheel depends upon the rolling angle f and upon a vertical load to which the motor vehicle is subjected.

Therefore, the estimation of the instantaneous slip λₛ by means of the slip reconstructor 113 preferably takes into account, in an inventive manner, the rotational speed ω_{f},ωᵣ of the front and rear wheels, the stroke of the front and rear suspensions x_{f},xᵣ, the longitudinal acceleration a and the rolling angle f of the vehicle.

Such measurements are detected through the plurality of sensors 122 foreseen on the motor vehicle 120.

Basically, a nominal slip value is calculated based upon the rotational speed ω_{f},ωᵣ of the front and rear wheels and the nominal value of the radius r of the wheels.

The nominal slip value subsequently corrected by means of a processing of the remaining measurements so as to correct the nominal radius in a way such as to approximate it as much as possible to the value of the actual instantaneous radius, also taking into account the influence of the longitudinal acceleration a on the longitudinal speed of the vehicle in its centre of mass and on the load transfer.

Such an instantaneous estimation of the instantaneous slip value λₛ makes it possible to have a reliable system which is able to operate even without one or more of the measurements used for the correction of the nominal slip.

In such a case, a less precise estimation of the slip will be obtained, but in any case it can be used for controlling the traction.

The closed loop controller 112 determines the first component t_{CL} of the torque requested to the motor 121 based upon the difference between the reference slip λ₀ and the estimated slip value λₛ.

In the case in which the estimated slip λₛ is lower than the reference slip λ₀, a greater torque shall be requested to the motor. Similarly, in the case in which the estimated slip λₛ is greater than the reference slip λ₀, a lower torque shall be requested to the motor.

Moreover, the measurement of the speed v of the vehicle is used to modify the calibration of the closed loop controller 112 and the mixing parameter μ.

In particular, the singularities of the controller 112 are moved in high frequency as the speed v increases. The calibration of the controller is also influenced by the gear inserted. In particular, the gain of the controller is modified so as to compensate the variations due to different transmission ratios.

In order to avoid discontinuity in the torque requested to the motor 121, the first component t_{CL} of the torque determined by the closed loop controller 112 is added to the torque t_{hold} that the motor 121 was exerting the moment the control system 100 was activated. Moreover, the first component t_{CL} of the torque is set equal to zero every time the closed loop controller 112 is activated.

In addition to the torque t_{CL} request determined by the closed loop controller 112, the feedforward controller 114 determines the second torque component t_{OL} to be requested to the motor 121.

Such a first t_{CL} and second t_{OL} torque components to be requested to the motor 121 have a greater or lower impact upon the total torque t₀ request as a function of the mixing parameter μ which is used to weigh the frequency of the two components.

In particular, the mixing parameter μ is used to modify the band of the closed loop control system 112 and the reaction speed of the feedforward component 114. Specifically, if μ=1, the bandwidth of the closed loop control system has a maximum value, whereas the feedforward control term is highly filtered. In such a configuration, the control of the traction of the motor vehicle mainly occurs in a closed loop ensuring a high level of reliability, but being able to be, on some vehicles, slow in following the slip reference.

Otherwise, if μ=0, the bandwidth of the closed loop control system has a minimum value, whereas the feedforward control has a slightly filtered action. In such a configuration the motor vehicle behaves like a generic two-wheeled vehicle driven in torque.

By modifying the value of the mixing parameter μ, it is possible to obtain optimal mixtures in frequency of the component t_{CL} deriving from the closed loop control and of the component t_{OL} deriving from the feedforward control.

The value of the mixing parameter μ can depend upon the selection carried out by the user through the user interface 140, on the speed v of the vehicle as well as on the rolling angle f.

Finally, the control block 110 is kept active carrying out the adjustment of the torque requested t₀ to the motor 121 to when the torque requested by the user through the conventional system for controlling the motor illustrated previously is maintained greater than the torque requested from the system for controlling the traction 100 according to the present invention.

Otherwise, the control block 110 is deactivated. From the description made the characteristics of the system and method for controlling traction in a two-wheeled vehicle object of the present invention should be clear, just as the relative advantages should also be clear.

Indeed, the method for controlling traction in a two-wheeled vehicle, operating a generation of a variable reference slip value as a function of a parameter representative of a torque request from a user, allows the user to control the slip and does not act to merely limit it.

Moreover, by determining the reference value of the slip through the maps which correlate the slip with both the speed of the vehicle, and the rolling angle at which the vehicle is, is able to ensure a high level of stability of the vehicle whilst still offering the best performance that can be achieved dependent upon the particular driving condition.

Moreover, the instantaneous slip value is estimated in a precise manner making the entire closed-loop control particularly sturdy.

Last but not least, thanks to the feedforward control component, the system is able to offer a rapid reaction whilst still being able to adapt to the instantaneous conditions of the vehicle and of the road surface.

Finally, it should be clear, that the system and the method for controlling traction in a two-wheeled vehicle thus conceived can undergo numerous modifications and variants, all covered by the invention; moreover, all the details can be replaced by technically equivalent elements.

1. Method for controlling traction in a two-wheeled vehicle comprising a torque controlled motor and a plurality of sensors for instantaneously measuring driving parameters (v, f, θ, ω, x, a, RPM, gear) of said vehicle, the method comprising the steps of:
determining a reference slip value (λ₀) as a function of a parameter (θ) representative of a torque request from a user, said parameter (θ) representative of a torque request being detected by means of said plurality of sensors;
estimating an instantaneous slip value (λ_{S});
determining a first component (τ_{CL}) of a requested torque signal to said motor based on the difference between said reference slip value (λ₀) and said instantaneous slip value (λ_{S});
wherein said reference slip value (λ₀) is determined by means of a torque-slip map correlating said parameter (θ), representative of a torque request, with a slip (λ), said couple-slip map varying as a function of a longitudinal speed (v) and a rolling angle (φ) of said two-wheeled vehicle detected by means of said plurality of sensors.

2. Method for controlling traction in a two-wheeled vehicle according to claim 1, further comprising the steps of recording an initial slip value (λ_{hold}), an initial value of said rolling angle (φ_{hold}) and an initial value of said parameter (θ_{hold}) representative of a torque request characterising said vehicle upon activating the traction control; said torque-slip map satisfying the following conditions:
said reference slip value (λ₀) corresponds to a maximum slip value (λₘₐₓ) allowed for said longitudinal speed (v) and said rolling angle (φ), when said parameter (θ) representative of a torque request presents a maximum value;
said reference slip value (λ₀) corresponds to said initial slip value (λ_{hold}) when said parameter (θ) representative of a torque request corresponds to said initial value of said parameter (θ_{hold}) representative of a torque request and when said rolling angle (φ) corresponds to said initial value of said rolling angle (φ_{hold}); and
said reference slip value (λ₀) equals zero, when said parameter (θ) representative of a torque request equals zero.

3. Method for controlling traction in a two-wheeled vehicle according to claim 2, wherein said maximum slip value (λₘₐₓ) is chosen based on a first plurality of maps of thresholds defining a maximum slip value (λₘₐₓ) and a minimum slip value (λₘᵢₙ) as a function of said longitudinal speed (v) and said rolling angle (φ).

4. Method for controlling traction in a two-wheeled vehicle according to claim 3, further comprising a step of checking at least one activation condition of the traction control, said at least one activation condition being that of exceeding a minimum slip (λₘᵢₙ) chosen based on said first plurality of maps of thresholds, or a minimum speed of variation of said parameter (θ) representative of a torque request from a user chosen based on a second plurality of maps of thresholds defining a minimum variation speed value of said parameter (θ) representative of a torque request from a user as a function of said longitudinal speed (v) and of said rolling angle (φ).

5. Method for controlling traction in a two-wheeled vehicle according to claim 1, wherein said parameter (θ) representative of a torque request is the opening angular position of an accelerator of said vehicle or of a throttle valve of said vehicle.

6. Method for controlling traction in a two-wheeled vehicle according to claim 1, wherein said step of estimating an instantaneous slip value (λ_{S}) consists of calculating a nominal slip value based on a rotational speed (ω_{f}, ωᵣ) of a front wheel and a rear wheel of said vehicle detected by said plurality of sensors and a nominal value of radius (r) of said wheels, and correcting said nominal slip value based on at least one of the measurements detected by means of said plurality of sensors comprising:
a stroke of a front suspension (x_{f}) of said vehicle;
a stroke of a rear suspension (xᵣ) of said vehicle;
a longitudinal acceleration (a) of said vehicle;
said rolling angle (φ) of said vehicle.

7. Method for controlling traction in a two-wheeled vehicle according to claim 1, further comprising a step of determining a second component (t_{OL}) of a requested torque signal to said motor based on at least one of said parameter (θ) representative of a torque request from a user, said longitudinal speed (v), said rolling angle (φ) and a motor speed (RPM) detected by means of said plurality of sensors.

8. Method for controlling traction in a two-wheeled vehicle according to claim 7, wherein said first component (t_{CL}) of a torque signal and said second component (t_{OL}) of a torque signal are added to a torque signal (t_{hold}) corresponding to the torque requested to said motor upon activating the traction control.

9. Method for controlling traction in a two-wheeled vehicle according to claim 7, wherein said first component (t_{CL}) of a torque signal and said second component (t_{OL}) of a torque signal are frequency-mixed through a mixing parameter (μ) adapted to filter to a greater extent a first component of said two components of a torque signal (t_{CL}, t_{OL}) with respect to the other.

10. System for controlling traction in a two-wheeled vehicle, said two-wheeled vehicle comprising a torque controlled motor and a plurality of sensors for instantaneously measuring driving parameters (v, f, θ, ω, x, a, RPM, gear) of said vehicle, said system comprising a control block coupled to said motor in order to provide a signal (t₀) corresponding to a requested torque as an input to said motor, said control block being connected as an input to said plurality of sensors, said control block comprising a closed loop controller adapted to determine a first component (t_{CL}) of said signal (t₀) corresponding to a requested torque, connected as an input to a slip reconstructor for estimating an instantaneous slip (λ_{S}) and to a reference generator for generating a reference slip (λ₀), wherein said reference generator is adapted to determine a reference slip (λ₀) based on a torque-slip map correlating a parameter (θ) representative of a torque request detected my means of said plurality of sensors with a slip (λ), said torque-slip map varying as a function of a longitudinal speed (v) and a rolling angle (φ) detected by means of said plurality of sensors.

11. System for controlling traction in a two-wheeled vehicle according to claim 10 wherein said slip reconstructor is connected as an input to said plurality of sensors in order to estimate said instantaneous slip (λ_{S}) by determining a nominal slip value based on a speed of rotation (ω_{f},ωᵣ) of a front wheel and of a rear wheel of said vehicle detected by means of said plurality of sensors and a nominal value of radius (r) of said wheels, and by correcting said nominal slip value based on at least one of the measurements detected by means of said plurality of sensors comprising:
a stroke of a front suspension (x_{f}) of said vehicle;
a stroke of a rear suspension (xᵣ) of said vehicle;
a longitudinal acceleration (a) of said vehicle;
said rolling angle (f) of said vehicle.

12. System for controlling traction in a two-wheeled vehicle according to claim 10, further comprising at least one feedforward controller (114) adapted to determine a second component (t_{OL}) of said signal (t₀) corresponding to a torque requested based on a plurality of instantaneous driving parameters of said vehicle detected by means of said plurality of sensors.

13. System for controlling traction in a two-wheeled vehicle according to claim 12 wherein the action of said closed loop controller and said feedforward controller is mixed through a mixing parameter (μ) adapted to modify the bandwidth of the same.

14. System for controlling traction in a two-wheeled vehicle according to claim 10 wherein it comprises a supervision block adapted to manage the activation of said control block upon exceeding at least one activation parameter comprising a minimum slip value (λₘᵢₙ) and a minimum variation speed value of said parameter (θ) representative of a torque request from a user.

15. System for controlling traction in a two-wheeled vehicle according to claim 10, further comprising a user interface comprising a plurality of selectors for setting managing parameters of said control block.
